(19) United States
(12) Patent Application Publication
(10) Pub. No.: US 2007/0236036 A1
(43) Pub. Date: Oct. 11, 2007

(54) Articulated component

(75) Inventor: Brian Downey, Westland, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Nissan Technical Center North America, Inc.

(21) Appl. No.: 11/391,849

(22) Filed: Mar. 29, 2006

(51) Int. Cl. B60R 7/00; A47K 1/08

(52) U.S. Cl. 296/37.1; 248/311.2

(57) ABSTRACT

In an exemplary embodiment, an articulated component is described having a body selectively movable between a stowed position and an extended position. A cover is in mechanical communication with the body, the cover being selectively movable between an open position and a closed position whereby selectively moving the cover into the open position biases the body into the extended position. Further, an exemplary method of articulating the component includes providing a housing having a cavity, securing at least one gear mechanism to the housing proximate the cavity, placing a body in mechanical communication with the at least one gear mechanism, and pivotally securing a cover to the housing proximate the cavity. The cover is selectively movable between an open position and a closed position and selectively moving the cover into the open position causes the body to be biased into the extended position. The body is at least partially disposed in the cavity in the stowed position.

### TECHNICAL FIELD

Described herein is an illustrative system and method for articulating a component in a vehicle.

### BACKGROUND

Automotive interiors have various trim assemblies to improve the comfort and convenience of vehicle occupants and enhance the aesthetic appearance of the interior. Examples of these interior trim assemblies include the instrument panels, armrests, door panels, and consoles. In certain trim assemblies, such as some center consoles, it is desirable to incorporate a compartment to allow the vehicle occupant to conveniently store items, e.g., coins, maps, CDs, and the like, typically carried in a vehicle. In many cases, the compartment includes a door or cover that overlies the opening and secures the items within the compartment. In addition, some consoles are provided with multiple storage compartments, as well as separate pen and pencil holders, tissue holders, cup holders, and the like.

Other center consoles include compartments adapted to provide storage for food and/or drink items, and entertainment devices, such as DVD players. These devices may be provided in conjunction with one or more storage compartments. By integrating various amenities into a console, space can be saved within the vehicle.

While consoles may be desirable to car owners and vehicle occupants, current consoles have some drawbacks. One drawback involves a lack of desired additional features or amenities to improve console functionality as well as provide greater comfort and convenience of vehicle owners and occupants.

For example, one additional desirable amenity includes having efficient storage components within the console for providing enhanced stowage. Another desirable amenity includes having storage compartments that can be articulated out of the center console and avoid contact with other items for quick access to desired items that may otherwise be buried among a plurality of items in the center console. Accordingly, other additional desired features may be incorporated that appear to be lacking in today's vehicle consoles.

### SUMMARY

In an exemplary embodiment, an articulated component is employed having a body selectively movable between a stowed position and an extended position. A cover is in mechanical communication with the body, the cover being selectively movable between an open position and a closed position, whereby selectively moving the cover into the open position biases the body into the extended position. Further, an exemplary method of articulating the component includes providing a housing having a cavity, securing at least one gear mechanism to the housing proximate the cavity, placing a body in mechanical communication with the at least one gear mechanism, and pivotally securing a cover to the housing proximate the cavity. The cover is selectively movable between an open position and a closed position and selectively moving the cover into the open position causes the body to be biased into the extended position. The body is at least partially disposed in the cavity in the stowed position.

### BRIEF DESCRIPTION OF THE DRAWINGS

The features and inventive aspects of the present invention will become more apparent from the following detailed description, the appended claims, and the accompanying drawings, of which the following is a brief description:

FIG. 1 is a perspective view of an embodiment of a center console shown between a driver's seat and a front passenger's seat of a vehicle;

FIG. 2 is a perspective view of the center console of FIG. 1 showing the top cover assembly in an open position and an articulated component in an extended position;

FIG. 3 is a side view of the center console of FIG. 1, taken from the driver's seat perspective and showing the articulated component extending upwardly and outwardly from a main stowage compartment and resting above a parking brake handle in a secured position; and

FIG. 4 is a side view of the center console of FIG. 1 taken from the passenger's seat perspective and showing a cutaway detailed view of an exemplary gear mechanism.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description.

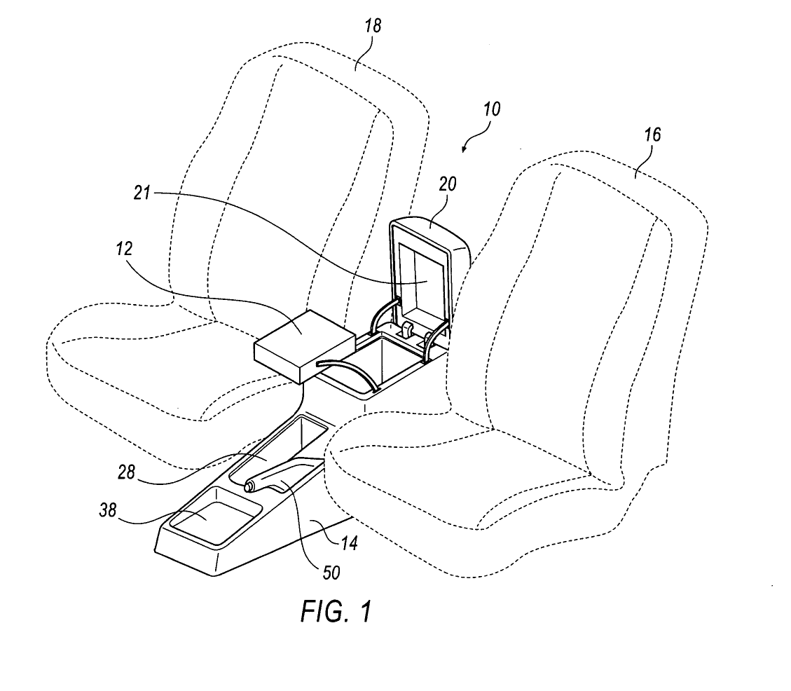

Referring now to FIG. 1, there is shown an exemplary center console 10 in a vehicle (not shown) having an exemplary embodiment of an articulated component 12 that may be included as original factory equipment, dealer-installed, or owner-retrofitted. The articulated component 12 takes advantage of otherwise unused or reconfigured space in the center console 10, roof console (not shown), and the like. Further, the articulation layout and method is unique in that it avoids contact with other items in the vehicle while in motion, as further discussed below. Moreover, the articulated component 12 provides efficient storage within the center console 12 for efficient stowage of items.

The console 10 includes a housing 14 that may be constructed of a durable, lightweight, easily-molded material such as plastic and has a generally rectangular configuration. It should be understood that the console 10 may be constructed of other materials and come in a variety of shapes and sizes. Although the console 10 may be provided in a variety of locations within a vehicle's interior (not shown), the console 10 advantageously is adapted for use as a center floor console 10 positioned between a driver's seat 16 and a front passenger's seat 18 or intermediate back passenger seats (not shown). The top cover assembly 20 of the console 10 is further configured to provide an armrest for the vehicle occupants and may include a cover cavity 21 in its interior portion.

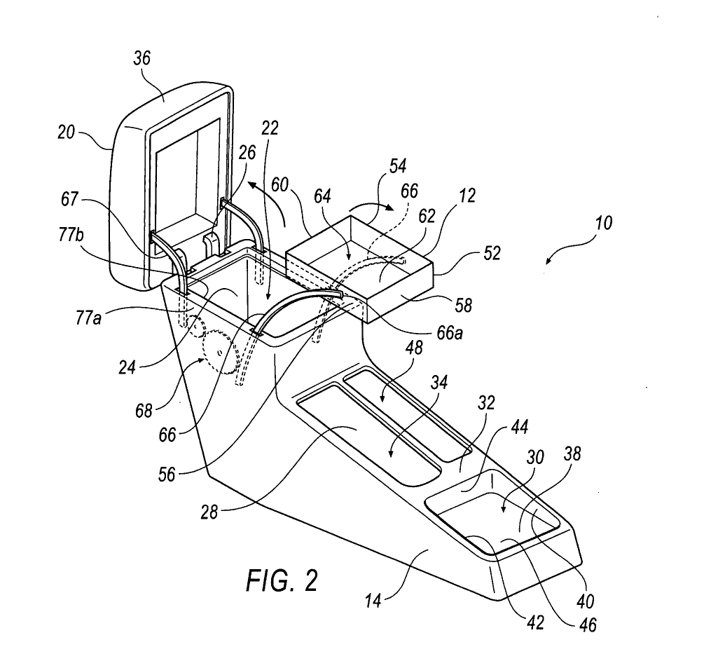

As best shown in FIG. 2, the housing 14 of the console 10 includes a main stowage compartment 22 situated below the top cover assembly 20 thereof and defining a cavity 24 adapted for storing various items (not shown) therein. The main stowage compartment 22 is placed in a closed position by moving the top cover assembly 20 in a downward direction. The top cover assembly 20 is pivotally coupled to the housing 14 by a hinge 26 or other hinge mechanism commonly known in the art, and is moveable between an open position as shown, wherein the cavity 24 may be accessed, and the closed position, wherein the top cover assembly 20 covers the cavity 24. The top cover assembly 20 may also be provided with a handle (not shown) for easy opening thereof.

As shown in FIG. 2, the housing 14 further includes optional first and second storage compartments 28 and 30. The consol 10 may or may not include the first and second storage compartment 28 and 30 depending on the predetermined requirements of the consol 10. Further, the consol 10 may include any number, size, and shape of storage compartments based on the requirements. The first storage compartment 28 is situated within a first upper surface 32 of the housing 14 and defines a first storage cavity 34 adapted for storing one or more items (not shown) such as coins, maps, CDs, etc. A lid (not shown) may be provided and pivotally coupled to the top surface 20 of the housing 12 by a hinge or other hinge mechanism commonly known in the art, and may be moveable between an open position, wherein the cavity 34 may be accessed, and a closed position, wherein the lid covers the cavity 34. A tambour door (not shown) may also be provided for selectively moving the first storage compartment 28 between the open and closed positions. The console 10, as earlier indicated, may further function as an armrest. Notably, an arm (not shown) of a vehicle occupant may be rested on an outer surface 36 of the top cover assembly 20 when the top cover assembly is in the closed position.

The second storage compartment 30 is situated within the first upper surface 32 of the housing 14 and defines a recessed area 38 adapted for storing one or more smaller items (not shown). Notably, the recessed area 38 includes opposing side walls 40 and 42, bottom wall 46, and a back wall 44 secured to the side walls 40, 42. Accordingly, the recessed area 38 is adapted to retain items (not shown), such as CDs, DVDs, headphones, apparel, etc., placed within the recessed area 38.

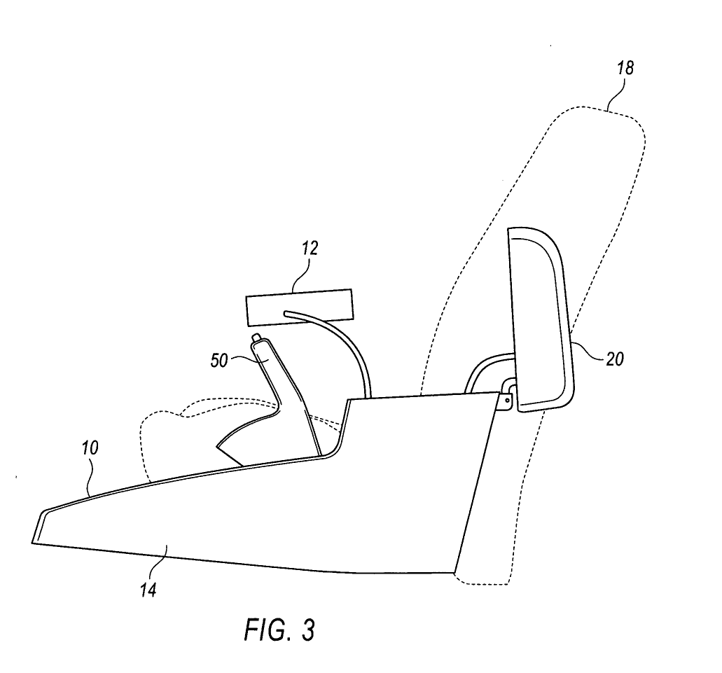

The housing 10 further includes a component opening 48 adapted to receive an automotive component such as a parking brake handle 50 as shown in FIG. 1. The opening 48 is adapted to allow the parking brake handle to move between a released position as shown in FIG. 1 and a secured position as shown in FIG. 3. In the secured position, the parking brake handle 50 is in an upwardly pointing orientation. In the released position, the parking brake handle 50 is in a generally forwardly pointing orientation and rests relatively proximate the housing 14. The articulated component 12 is adapted to be disposed above the handle 50 in an extended position as shown in FIG. 3 and further described below.

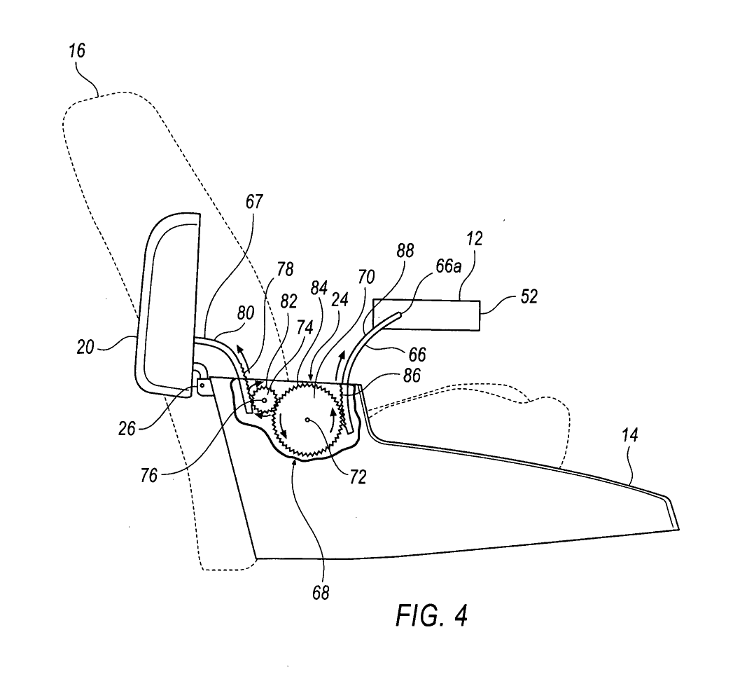

As shown in FIG. 2, the articulated component 12 includes a body 52 having opposing side walls 54, 56, a front wall 58, a rear wall 60, and a bottom wall 62. The walls are secured to one another to form a generally box-like arrangement having an opening 64. The body may be a storage compartment or any desired device. The body 52 is secured to at least one first arm 66 that is in mechanical communication with a gear mechanism 68. The first arm 66 may be immovably fixed or pivotally fixed at a first arm point 66a or may be slideable along a groove (not shown) disposed along the outer surfaces of sidewalls 54, 54 of the body 52. The top cover assembly is secured to at least one second arm 67 that is also in mechanical communication with the gear mechanism 68. In FIG. 4, an exemplary gear mechanism 68 is shown to include a first gear 70 secured to the housing 14 at a first mounting point 72. The first gear 70 rotates about the first mounting point 72 and is in mechanical communication with a second gear 74. The second gear 74 is secured to the housing 14 at a second mounting point 76. The gear mechanism 68 is shown to be disposed between a first housing wall 77a and a second housing wall 77b of the housing 14.

In operation, as the top cover assembly 20 is rotated from the perspective of the front passenger's seat 18 about the hinge 26 in a counter-clockwise direction from the closed position to the open position, the second arm 67 moves upwardly and outwardly away from the cavity 24. The second arm 67 includes a plurality of second arm teeth 78 disposed at least partially along a second arm surface 80 and in mechanical communication with a plurality of second gear teeth 82 of the second gear 74. The upward and outward movement of the second arm 67 biases the second gear 74 in a clockwise rotation about the second mounting point 76. As the second gear 74 rotates clockwise about the second mounting point 76, it biases the first gear 70 into a counterclockwise rotation. The second gear teeth 82 are in mechanical communication with the first gear teeth 84. The first arm 66 includes a plurality of first arm teeth 86 at least partially disposed on a first arm surface 88. As the first gear 70 rotates counterclockwise around the first mounting point 72, the first gear teeth 84 that are in mechanical communication with the first arm teeth 86, move the first arm in an upwardly and outwardly opposite direction from the second arm 67. Therefore, moving the top cover assembly 20 from the closed position to the open position moves the body 52 from the stowed position to the extended position as shown in FIG. 4. The stowed position may include the body being at least partially disposed in the cavity 24 of the main stowage compartment 22 and/or at least partially disposed in the top cover assembly.

A method of articulating the component 12 includes providing the housing 14 having the cavity 24; securing at least one gear mechanism 68 to the housing 14 proximate the cavity 24; placing the body 12 in mechanical communication with the at least one gear mechanism 68; pivotally securing the cover 20 to the housing 14 proximate the cavity 24, the cover 20 being selectively movable between the open position and the closed position; and selectively moving the cover 20 into the open position, thereby biasing the body 12 into the extended position, the body 12 being at least partially disposed in the cavity 24 in the stowed position. The method may further include articulating the body 12 upwardly and outwardly away from the cavity 24 when the cover 20 is moved to the open position. The method may also include pivotally securing the cover 20 by disposing the cover 20 over the cavity 24 of the housing 14 in the closed position. Further, the method may include the body 12 being at least partially disposed within the cover 20 in the stowed position.

The preceding description has been presented only to illustrate and describe exemplary embodiments of the methods and systems of the claimed invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. An articulated component comprising:
a body selectively movable between a stowed position and an extended position; and
a cover in mechanical communication with the body, the cover being selectively movable between an open position and a closed position;
whereby selectively moving the cover into the open position biases the body into the extended position.

2. The articulated component of claim 1, wherein the body is a storage compartment.

3. The articulated component of claim 1, wherein the body is in mechanical communication with at least one gear.

4. The articulated component of claim 1, wherein at least one gear is disposed between the body and the cover.

5. The articulated component of claim 4, wherein a first gear is in mechanical communication with the body and a second gear is in mechanical communication with the cover.

6. The articulated component of claim 5, wherein a first arm is disposed between the body and the first gear, the first arm being selectively secured to the body and in mechanical communication with the first gear.

7. The articulated component of claim 5, wherein a second arm is disposed between the cover and the second gear, the second arm being selectively secured to the cover and in mechanical communication with the second gear.

8. The articulated component of claim 1, wherein the body is at least partially disposed in a cavity of a housing in the stowed position.

9. The articulated component of claim 8, wherein the body is articulated upwardly and outwardly away from the cavity when the cover is moved to the open position.

10. The articulated component of claim 1, wherein the cover is disposed over a cavity of a housing in the closed position.

11. The articulated component of claim 1, wherein the body is at least partially disposed in the cover in the stowed position.

12. An articulated component comprising:
a housing having a cavity;
a body selectively movable between a stowed position and an extended position, the body being at least partially disposed in the cavity in the stowed position;
a first gear secured to the housing and being in selective mechanical communication with the body;
a second gear secured to the housing and being in selective mechanical communication with the first gear; and
a cover in mechanical communication with the second gear, the cover being selectively movable between an open position and a closed position;
whereby selectively moving the cover into the open position biases the body into the extended position.

13. The articulated component of claim 12, wherein the body is a storage compartment.

14. The articulated component of claim 12, wherein the body is articulated upwardly and outwardly away from the cavity when the cover is moved to the open position.

15. The articulated component of claim 12, wherein the cover is disposed over the cavity of the housing in the closed position.

16. The articulated component of claim 12, wherein the body is at least partially disposed in the cover in the stowed position.

17. A method of articulating a component comprising the steps of:
providing a housing having a cavity;
securing at least one gear mechanism to the housing proximate the cavity;
placing a body in mechanical communication with the at least one gear mechanism;
pivotally securing a cover to the housing proximate the cavity, the cover being selectively movable between an open position and a closed position; and
selectively moving the cover into the open position thereby biasing the body into the extended position, the body being at least partially disposed in the cavity in the stowed position.

18. The method of articulating a component of claim 17, wherein the step of articulating includes articulating the body upwardly and outwardly away from the cavity when the cover is moved to the open position.

19. The method of articulating a component of claim 17, wherein the step of pivotally securing the cover includes disposing the cover over the cavity of the housing in the closed position.

20. The method of articulating a component of claim 17, wherein the step of selectively moving the cover includes at least partially disposing the body in the cover in the stowed position.
